(19) United States
(12) Patent Application Publication
(10) Pub. No.: US 2026/0086987 A1
(43) Pub. Date: Mar. 26, 2026

(54) SYSTEMS AND METHODS OF DATABASE ENTITY CREATION

(71) Applicant: Salesforce, Inc., San Francisco, CA (US)

(72) Inventors: Ajay SINGH, Bangalore (IN); Surbhi PAREEK, Bangalore (IN); Sree Harini SOMA, Bangalore (IN); Sourav SIPANI, Bangalore (IN); Khyati GARG, Bangalore (IN); Anmol MITTAL, Bangalore (IN)

(21) Appl. No.: 18/894,172

(22) Filed: Sep. 24, 2024

(51) Int. Cl. G06F 16/21; G06F 16/22

(52) U.S. Cl. CPC G06F 16/212; G06F 16/213; G06F 16/2282

(57) ABSTRACT

Systems and methods are provided for retrieving metadata of one or more existing database entities. Vector embeddings for the one or more existing database entities may be generated. Data model attributes for a new database entity may be received, and new input metadata may be generated based on the data model attributes. A new vector embedding may be based on the generated new input metadata. One or more similarities may be determined between the generated new vector embedding and at least one of the generated vector embeddings of the one or more existing database entities. A recommendation of whether at least one of the generated vector embeddings that is determined to be similar to the new vector embedding is to be added to or modified based on the generated new input metadata may be received.

### BACKGROUND

Currently, designing database entities for new functionalities is a manual process to identify the essential entities (tables) needed to support the new functionalities. This involves manually determining if existing entities can be repurposed to avoid creating redundant data structures. The relationships between these new and existing entities to provide data consistency and efficient retrieval are performed manually.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-5 show example methods of database entity creation according to implementations of the disclosed subject matter.

FIGS. 6A-6B show an example of a system for database entity creation according to an implementation of the disclosed subject matter.

FIG. 7A shows an example query input according to an implementation of the disclosed subject matter.

FIG. 7B shows an example output in a markup language based on the query input of FIG. 7A according to an implementation of the disclosed subject matter.

FIG. 7C shows an example matched entity markup language according to an implementation of the disclosed subject matter.

FIGS. 7D-7E show an example prompt used for markup language creation according to an implementation of the disclosed subject matter.

FIG. 8 shows an example computer system to perform the example methods of FIGS. 1-5 and that includes the system shown in FIGS. 6A-6B according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter provide systems and methods of automating and improving database design for new use cases using generative artificial intelligence (AI). Entities (e.g., tables of a database) needed to support the new use case based on a product requirements document may be identified. Existing entities may be analyzed in the database, and implementations of the disclosed subject matter may propose opportunities to reuse one or more existing entities for the new use case, or add a new entity to the database when the existing entities are unable to be modified to address the use case. This may reduce redundancy and development time. When new entities are needed, definitions of such entities may be proposed, including their attributes and constraints. The systems and methods may propose relationships between new and existing entities. This may provide data integrity and efficient data retrieval from the database.

In implementations of the disclosed subject matter, metadata of existing entities may be retrieved, and vector embedding for the metadata are generated and stored in a vector storage. The vector embedding may be a compressed version of an object (text, image, entity, etc.) that is represented as a vector, which captures the essence of the object and its relationships to others in a lower-dimensional space, making it easier to process and analyze complex data.

Data model attributes for generating a new entity in a database may be embedded into a prompt to be provided to a generative AI system. The data model attributes may include instructions to create a file, along with details of the attributes. The generated file may be input metadata. Similarities between the new input metadata and metadata for existing entities of the databased may be determined. The similarity determination may identify a set of entities having the highest similarity score within a predetermined threshold (e.g., 80%, 85%, 90%, 95%, or the like) to determine one or more matched entities. Implementations of the disclosed subject matter may determine additions and/or modifications for the matched entities so that it can accommodate new and/or existing use cases.

Implementations of the disclosed subject matter improve upon the arrangements of traditional manual systems that are inherently prone to errors and inconsistencies, which can arise from human error in identifying entities, naming conventions, or defining relationships. Additionally, the lack of a systematic approach in current systems to entity reuse often leads to the creation of duplicate data structures, which wastes storage space, increases development time, and complicates future data management.

Implementations of the disclosed subject matter provide systems and methods of generating database design for new use cases. The systems and methods disclosed herein may be used to identify the entities (e.g., tables) to support the new use case based on data model attributes (e.g., a product requirements document or the like). The disclosed subject matter may analyze existing entities in the database and propose opportunities to reuse them for the new use case, reducing redundancy and development time. When it is determined that new entities are needed, the systems and methods of the disclosed subject matter may propose the definition of such entities, including one or more of their attributes and/or constraints. In some implementations, the disclosed subject matter may propose relationships between new and existing entities, which may provide data integrity and/or efficient data retrieval. In some implementations, generative artificial intelligence (AI) systems may be used to identify the entities, analyze existing entities, propose the definition of entities, and/or propose relationships between new and existing entities.

The inventive concept improves computing functionality by preventing the creation of redundant data structures in a database, and reduces storage space waste by preventing duplication of such data structures. The inventive concept improves the accuracy of creation of new database entities, and improves data consistency and efficient of retrieval by improving the definition of relationships between new and existing entities.

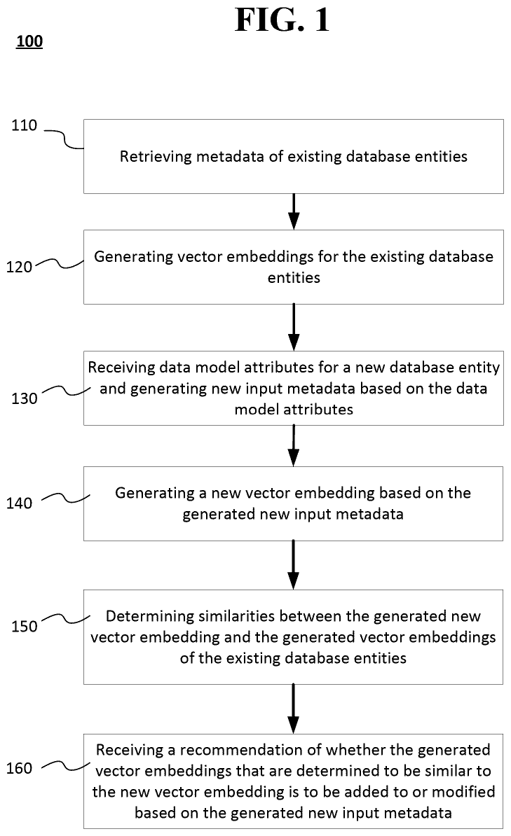

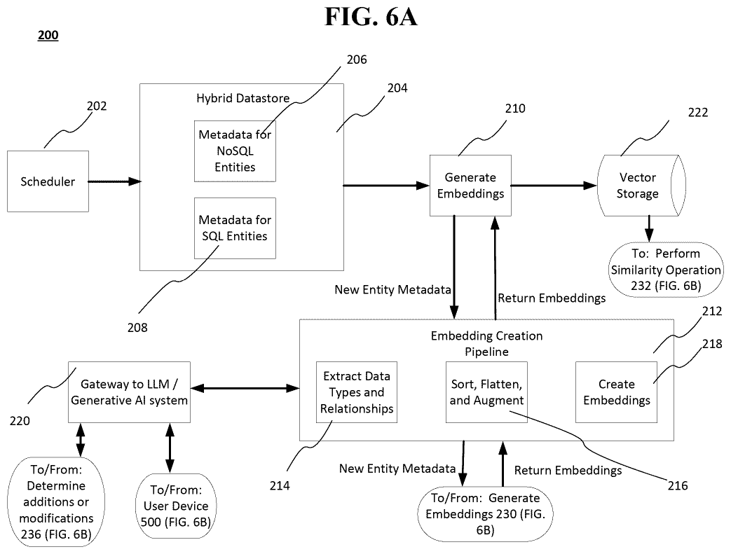

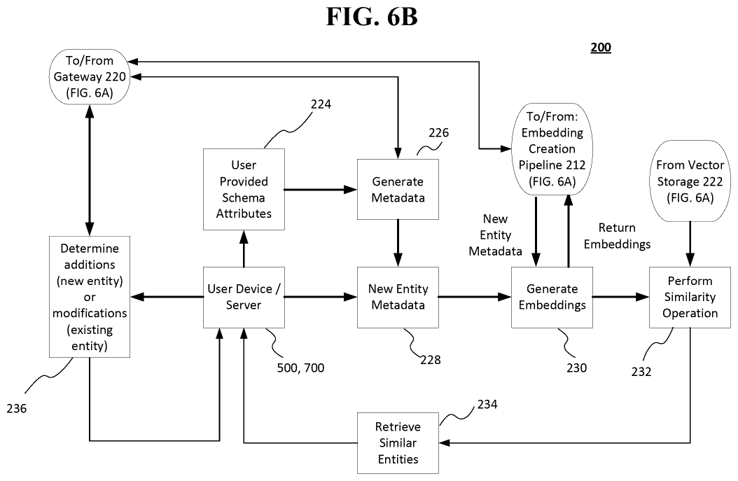

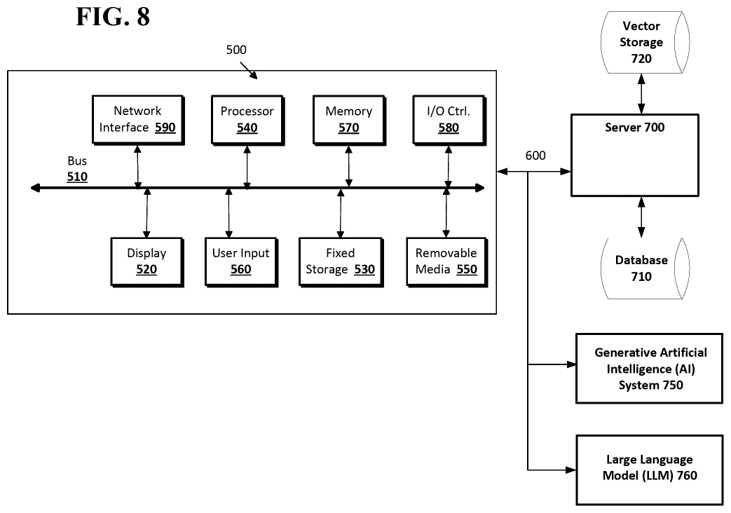

FIGS. 1-5 show an example method 100 of database entity creation according to implementations of the disclosed subject matter. At operation 110, a server (e.g., server 700 shown in FIG. 8 and described below) may retrieve metadata from one or more existing database entities. The database entities may be stored in hybrid datastore 204, which may include, for example, metadata for NoSQL entities 206, metadata for SQL entities 208, and the like. The NoSQL metadata may be for entities stored in a NoSQL database, where NoSQL is an approach to database design that focuses on providing a mechanism for storage and retrieval of data that other than the tabular relations used in relational databases. The SQL metadata may be for SQL database entities, where SQL (Structured Query Language) is a domain-specific language used to manage data, such as in a relational database management system and/or in handling structured data. The SQL and NoSQL database entities are merely examples, and there can be metadata for other types of database entities stored in the hybrid datastore 204. The hybrid datastore 204 may be stored in database 710 shown in FIG. 8, which is communicatively coupled to the server 700. The retrieval of the metadata from the hybrid datastore 204 may be performed by scheduler 202, described in detail below in connection with FIG. 6A.

At operation 120, vector embeddings may be generated for the one or more existing database entities. The vector embedding may be a compressed version of an object (e.g., text, an image, a database entity, or the like) represented as a vector. That is, the vector embedding may capture the essence of the object and its relationships to other objects. This may make it easier for models to process and/or analyze complex data. This generation of embeddings of operation 120 is also shown in the generate embeddings 210 operation shown in FIG. 6A. The metadata from the existing entities that is retrieved in operation 110 may be provided by the generate embedding operation 210 to the embedding creation pipeline 212 shown in FIG. 6A. Operation 214 shown in FIG. 6A may extract data types, relationships, and the like from the metadata for the existing entities. Operation 216 shown in FIG. 6A may sort, flatten, and/or augment the retrieved metadata. In some implementations, the server may denormalize the retrieved metadata of the one or more existing database entities to extract one or more parameters. For example, denormalizing may combine the retrieved metadata from the existing database entities before extracting the parameters. The parameters may be, for example, data type, the domain set, and/or description of the field. At operation 218 shown in FIG. 6A, vector embeddings may be created from the retrieved metadata that may have been sorted, flattened, augmented, and/or denormalized. The generated vector embeddings may be stored in a storage device (e.g., vector storage 222 shown in FIG. 6A, database 710 and/or vector storage 720 shown in FIG. 8) that is communicatively coupled to the server. These operations are described in detail below in connection with FIGS. 6A-6B.

At operation 130, the server may receive data model attributes for a new database entity and generate new input metadata based on the data model attributes. The new data model attributes may be received from the user device (e.g., computer 500) shown in FIG. 6B and FIG. 8 via a communications network 600. As described below in connection with FIGS. 6A-6B, the received data model attributes may be data model requirements and/or use-case descriptions. These data model attributes and/or use-case description may be in a text format, such as free-form text. As described in detail below, the received data model attributes may be used to determine whether a new data entity is to be created, or whether an existing data entity may be modified to meet the attributes of the received data model attributes. Generating the new input metadata based on the data model attributes is also shown in operation 226 of FIG. 6B and described in detail below.

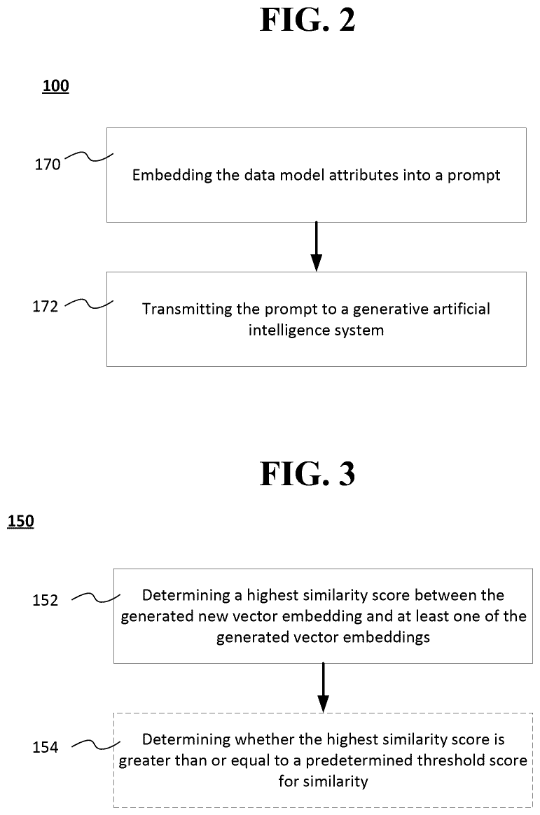

FIG. 2 shows additional operations to method 100 of FIG. 1 for generating the new input metadata according to implementations of the disclosed subject matter. At operation 170, the server may embed the data model attributes into a prompt. In some implementations, the data model attributes embedded in the prompt may include instructions for generating the new input metadata. At operation 180, the server may transmit the prompt to a generative artificial intelligence system that is communicatively coupled to the server. The server may transmit the prompt via the gateway 220 shown in FIG. 6A to generative artificial intelligence (AI) system 750 shown in FIG. 8 via the communications network 600. As described below in connection with FIGS. 6A-6B, the generative AI system 750 may generate the new input metadata based on the prompt.

At operation 140 of FIG. 1, the server may generate a new vector embedding based on the generated new input metadata. The new vector embedding may be a compressed version of the generated new input metadata, where the vector may be a series of numbers which represent the compressed version of the object. The vector embedding may capture the essence of the generated new input metadata, and may make it easier to compare the data model attributes with the existing entities that have metadata placed into vector form in operation 120.

At operation 150, the server may determine one or more similarities between the generated new vector embedding and at least one of the generated vector embeddings of the one or more existing database entities. FIG. 3 shows example operation for how the similarities between the generated new vector embedding and the generated vector embeddings may be determined. At operation 152, a highest similarity score between the generated new vector embedding and at least one of the generated vector embeddings may be determined. At operation 154, it may be determined whether the highest similarity score is greater than or equal to a predetermined threshold score for similarity. The threshold for similarity may be more than 80%, more than 85%, more than 90%, more than 95%, or the like.

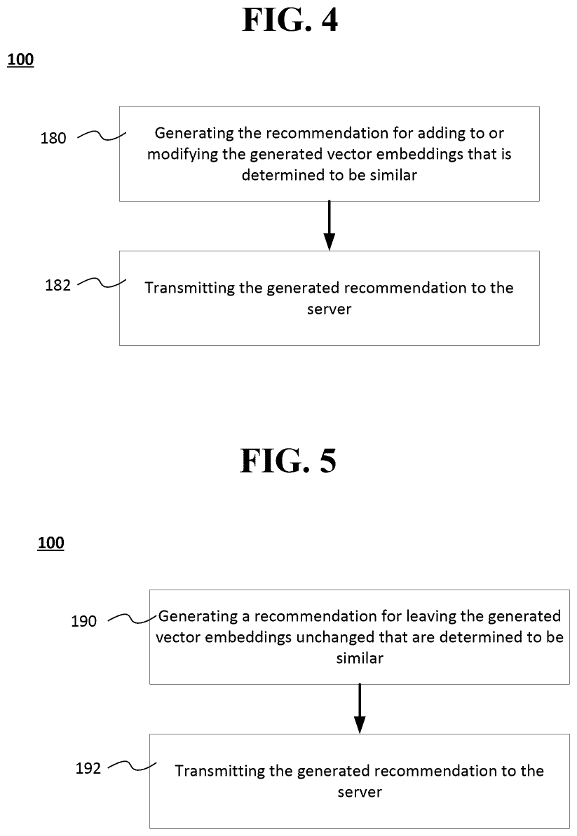

At operation 160, the server may receive a recommendation of whether at least one of the generated vector embeddings that is determined to be similar to the new vector embedding is to be added to or modified based on the generated new input metadata. FIG. 4 shows optional operations of method 100 for generating the recommendations received in operation 160 according to implementations of the disclosed subject matter. At operation 180, a generative artificial intelligence system may generate the recommendation for adding to or modifying the database entity having the generated vector embedding that is determined to be similar. The recommendations for adding a new entity and/or modifying at existing entity are discussed below in connection with operation 236 shown in FIG. 6B. The generative artificial intelligence system may be generative artificial intelligence system 750 shown in FIG. 8, which may be coupled to and/or be a part of gateway 220 shown in FIG. 6A. At operation 182, the generated recommendation may be transmitted from the generative artificial intelligence system to the server. For example, the server (e.g., server 750 shown in FIG. 8) may transmit the recommendations to user device (e.g., computer 500 shown in FIG. 8) for display.

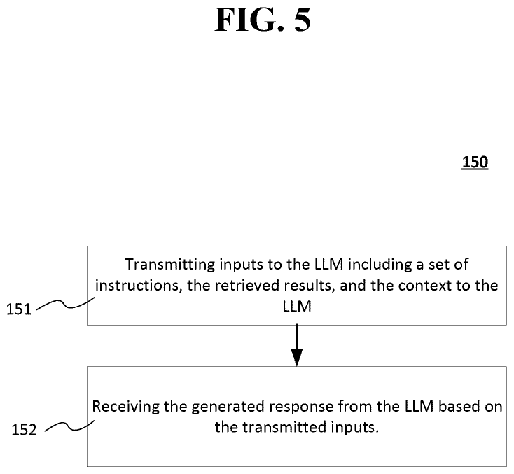

FIG. 5 shows optional operations of method 100 for generating the recommendations in operation 160 according to implementations of the disclosed subject matter. At operation 190, the generative artificial intelligence system (e.g., generative AI system 750 shown in FIG. 8) may generate the recommendation for leaving the at least one of the generated vector embeddings as unchanged that are determined to be similar. The recommendations for whether to adding a new entity, modifying at existing entity, or refrain from making any adjustments to existing entities to handle the new use case are discussed below in connection with operation 236 shown in FIG. 6B. At operation 192, the generated recommendation may be transmitted from the generative artificial intelligence system to the server (e.g., from generative AI system 750 to server 700 via communications network 600 shown in FIG. 8).

FIGS. 6A-6B show an example of a system 200 for database entity creation according to an implementation of the disclosed subject matter. In FIG. 6A, scheduler 202 may configure a scheduled job to take metadata of the existing entities (e.g., metadata from hybrid datastore 204), augment the metadata, and generate vector embeddings for the metadata. A vector embedding may be a compressed version of an object (e.g., text, an image, a database entity, or the like) represented as a vector. For example, the vector may be a series of numbers which represent the compressed version of the object. The vector embedding may capture the essence of the object and its relationships to other objects in a lower-dimensional space. This may make it easier for models to process and/or analyze complex data.

The metadata for the existing entities may be retrieved based on the scheduled job from scheduler 202 from the hybrid datastore 204, which may be part of database 710 shown in FIG. 8. The hybrid datastore 204 may include a storage 206 for metadata for NoSQL entities, and/or a storage 208 to store metadata for SQL entities. Vector embeddings may be generated at the generate embeddings operation 210, which may be performed by a server (e.g., server 700 shown in FIG. 8). The generate embeddings operation 210 may use an embedding creation pipeline 212. Operation 214 of the embedding creation pipeline 212 may extract data types and relationships (e.g., between exiting entities) from the metadata. The data types and/or relationships of the metadata may be extracted by de-normalizing the metadata. The parameters may include data type, domain set, and/or description of the fields. The data types and/or metadata may be sorted, flattened, and/or augmented at operation 216. The vector embeddings may be generated at operation 218 based on the de-normalized, sorted, augmented, and/or flattened data types. The generated vector embeddings may be stored in vector storage 222, which may be part of vector storage 720 shown in FIG. 8.

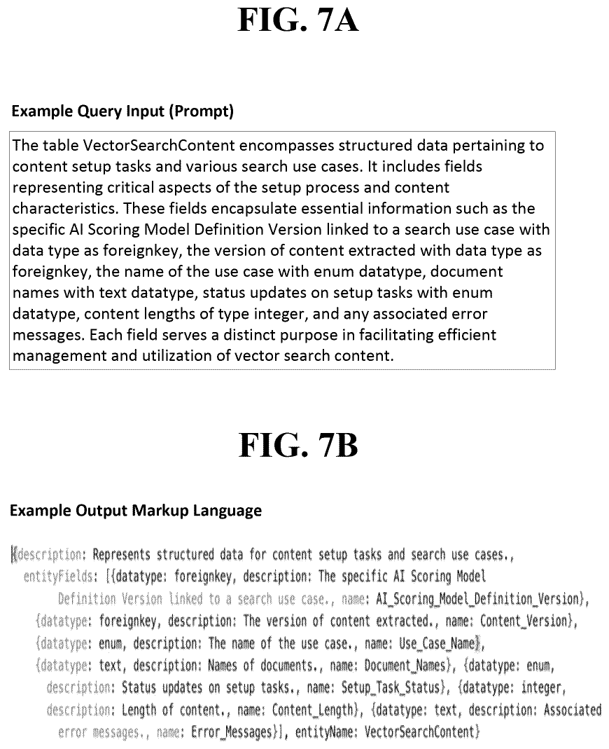

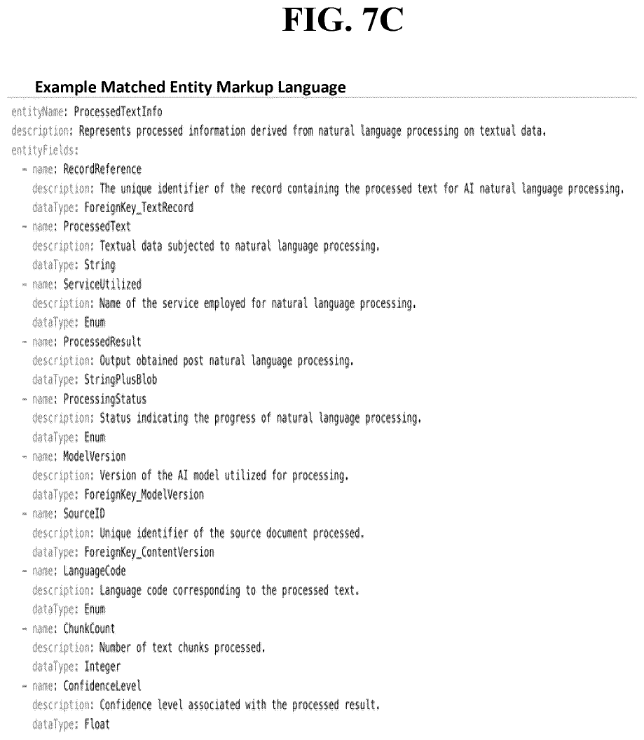

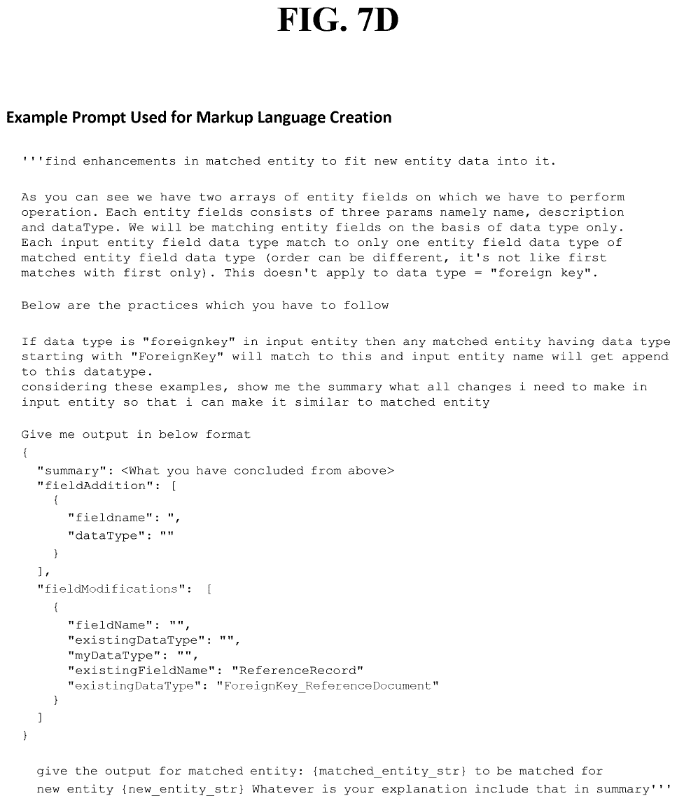

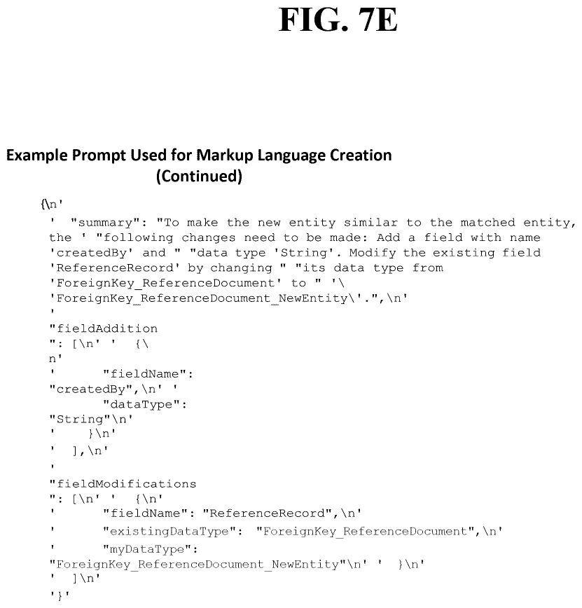

FIG. 6B shows generating a prompt for data model metadata creation. The server (e.g., server 700 shown in FIG. 8) may receive data model attributes (e.g., data model requirements) and/or use-case description from a user device (e.g., computer 500 shown in FIG. 6B and FIG. 8). The data model attributes and/or use-case description may be in a text format, such as free-form text. The data model attributes may be user-provided schema attributes 224, which may be transmitted to operation 226 to generate metadata. Operation 226 may generate a prompt to be provided to gateway 220 of FIG. 6A, which is a Large Language Model (LLM) or a generative AI system. The prompt may include instructions to create a markup language file (e.g., a YAML file (YAML Ain't Markup Language™, which is a human-friendly data serialization language)) and details of the data model attributes. An example query input (i.e., the prompt) is shown in FIG. 7A, and FIG. 7B shows the example output in a markup language. The example prompt in FIG. 7A may be a natural language text (e.g., English language) which describes a table with structured tasks related to content and use cases. The prompt includes descriptions of the fields of the table, data types, use case names, document tames, content length, status updates, and the like. The example of the output in the markup language shown in FIG. 7B may include markup for the description, the entity fields, data types, descriptions, error messages, and the like.

The markup language file may be used input metadata (e.g., new entity metadata 228 shown in FIG. 6B). The metadata that is generated based on the prompt may be used to generate vector embeddings at operation 230, where the embedding creation pipeline 212 may be used as described above in connection with FIG. 6A. That is, the data types and/or relationships may be extracted (at operation 214), the data types and/or relationships may be sorted, flattened and/or augmented at operation 216, and the vector embeddings may be created at operation 218 of the embedding creation pipeline 212.

Operation 232 shown in FIG. 6B may perform a similarity operation on the vector embeddings generated at operation 230 from the prompt and the vector embeddings of the existing metadata in the hybrid datastore 204 that are stored in the vector storage 222. Operation 232 may receive the generated embeddings from operation 230, and may retrieve the vector embeddings from the vector storage 222. Cosine similarity, Manhattan distance, or other suitable techniques may be used to perform the similarity operation at operation 232. Cosine similarity is a metric that may be used to compare the direction of two vectors. In a nearest neighbor search, cosine similarity may find the data points (e.g., entities) in a high-dimensional space that are similar to a given query point. If two or more vector embeddings are imagined as arrows, cosine similarity may equate to how closely the angles of the arrows are aligned, where a higher value may indicate greater similarity. Using cosine similarity or other suitable techniques may efficiently identify the closest neighbors (i.e., most similar entities) to a query based on their embedded representations. The server may identify a set of entities (e.g., of the existing entities in the database based on the metadata stored in the hybrid datastore 204) having the highest similarity score with new metadata (generated at operation 230) with a threshold of, for example, more than 80%, more than 85%, more than 90%, more than 95%, or the like.

Once similar entities are determined at operation 232 in FIG. 6B, the server may provide the similar entities to the user device (e.g., computer 500) and/or server 700 at operation 234. Additions and/or modifications may be determined at operation 236 for the matched entity so that it can accommodate existing and new use cases. For each matched entity, the metadata may be sent to gateway 220 of FIG. 6A along with the new entity metadata to determine the differences and probable enhancements needed. A prompt may be sent to the LLM (e.g., LLM 760 shown in FIG. 8) or generative AI (e.g., generative AI 750 shown in FIG. 8) via the gateway 220, where the prompt may be embedded with examples and/or key points to be considered when generating recommendations for additions to the existing entities. FIG. 7C shows an example of the markup language that may be used to generate the recommendations, and may include the entity name, the description of the entity, and the name, description, and datatypes for each of the entity fields. FIGS. 7D-7E show an example prompt that may be provided to the LLM or generative AI to generate the recommendations for additions and/or modifications to the existing entities. The example prompt may include a request to find a matched entity to fit new entity data into, and may describe the entity as having arrays of entity fields, which include the parameters of name, description, and datatype. The prompt may provide the request to match the entity fields based on datatype, but this is merely an example. The prompt may provide the practices that should be followed, and request that a summary be provided that includes the changes to be made. The prompt may also request a format for the output.

The LLM or generative AI may return recommendations to user device (e.g., computer 500) and/or the server 700, which may include whether the matching entity should be unchanged (as an existing entity matches the prompt to generate a new entity), what modifications may be made to an existing entity to make it similar to the data model attributes provided, and/or what additions (e.g., new entity) may be made based on the data model attributes. Although deletions may be recommended as a modification to an existing entity, there may be issues with backward compatibility, as it may disrupt operation of the one or more database entities for existing use-cases.

Implementations of the disclosed subject matter may be implemented in and used with a variety of component and network architectures. FIG. 8 is an example computer 500 suitable for the operations detailed in method 100 and FIGS. 1-5, and as part of system 200 shown in FIGS. 6A-6B. As discussed in further detail herein, the computer 500 may be a single computer in a network of multiple computers. The computer 500 may be a device used by an agent in connection with the example methods discussed above in connection with FIGS. 1-5, and in connection with FIGS. 6A-6B.

In some implementations, the computer 500 may communicate with and may be used to receive one or more responses generated by server 700, generative AI system 750, large language model (LLM) 760, via communications network 600. The server 700, the generative AI 750, and/or the LLM 760 may be one or more hardware servers, virtual machines, cloud servers, databases, clusters, application servers, neural network systems, processors, devices, computers, or the like. Although one server 700, database 710, vector storage 720, generative AI system 750, and/or LLM 760 there may be a plurality of servers and or databases communicatively coupled to communications network 600 which may operate in concert with one another. The server 700 may be communicatively coupled to database 710 and vector storage 720, and/or may include database 710 and/or vector storage 720. In some implementations, the vector storage 720 may be part of the database 710. The database 710 and/or the vector storage 720 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as tenant data (e.g., in a multi-tenant database system), application data, and the like. The vector storage 720 may store generated vector embeddings of metadata as described above. The generative AI system 750 and/or the LLM 760 may generate the recommendation for adding to or modifying the database entity, and/or generate the recommendation for adding generating the new input metadata based on prompt to or modifying the database entity as described above.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks. The service resource 404 and/or one or more user devices 750 may have components that are similar to the computer 500 described above.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 6 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “retrieving”, “generating”, “determining”, “receiving”, “denormalizing”, “storing”, “transmitting”, “embedding”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
retrieving, at a server, metadata of one or more existing database entities;
generating vector embeddings for the one or more existing database entities;
receiving, at the server, data model attributes for a new database entity and generating new input metadata based on the data model attributes;
generating, at the server, a new vector embedding based on the generated new input metadata;
determining, at the server, one or more similarities between the generated new vector embedding and at least one of the generated vector embeddings of the one or more existing database entities; and
receiving, at the server, a recommendation of whether at least one of the generated vector embeddings that is determined to be similar to the new vector embedding is to be added to or modified based on the generated new input metadata.

2. The method of claim 1, further comprising:
denormalizing the retrieved metadata of the one or more existing database entities to extract one or more parameters.

3. The method of claim 1, further comprising:
storing the generated vector embeddings in a storage device that is communicatively coupled to the server.

4. The method of claim 1, further comprising:
embedding, at the server, the data model attributes into a prompt; and
transmitting, at the server, the prompt to a generative artificial intelligence system that is communicatively coupled to the server.

5. The method of claim 4, wherein the data model attributes embedded in the prompt include instructions for generating the new input metadata.

6. The method of claim 1, wherein the determining the one or more similarities comprises:
determining a highest similarity score between the generated new vector embedding and at least one of the generated vector embeddings.

7. The method of claim 6, further comprising:
determining whether the highest similarity score is greater than or equal to a predetermined threshold score for similarity.

8. The method of claim 1, further comprising:
generating, at a generative artificial intelligence system communicatively coupled to the server, the recommendation for adding to or modifying the at least one of the generated vector embeddings that is determined to be similar; and
transmitting the generated recommendation to the server.

9. The method of claim 1, further comprising:
generating, at a generative artificial intelligence system communicatively coupled to the server, the recommendation for leaving unchanged the at least one of the generated vector embeddings that is determined to be similar; and
transmitting the generated recommendation to the server.

10. A system comprising:
a server communicatively coupled to a database system, the server configured to:
retrieve metadata of one or more existing database entities of the database system;
generate vector embeddings for the one or more existing database entities;
receive data model attributes for a new database entity and generate new input metadata based on the data model attributes;
generate a new vector embedding based on the generated new input metadata;
determine one or more similarities between the generated new vector embedding and at least one of the generated vector embeddings of the one or more existing database entities; and
receiving, at the server, a recommendation of whether at least one of the generated vector embeddings that is determined to be similar to the new vector embedding is to be added to or modified based on the generated new input metadata.

11. The system of claim 10, wherein the server is configured to denormalize the retrieved metadata of the one or more existing database entities to extract one or more parameters.

12. The system of claim 10, further comprising:
a storage device communicatively coupled to the server,
wherein the server is configured to store the generated vector embeddings in the storage device.

13. The system of claim 10, wherein the server is configured to embed the data model attributes into a prompt, and transmit the prompt to a generative artificial intelligence system that is communicatively coupled to the server.

14. The system of claim 13, wherein the data model attributes embedded in the prompt include instructions for generating the new input metadata.

15. The system of claim 10, wherein the server is configured to determine the one or more similarities by determining a highest similarity score between the generated new vector embedding and at least one of the generated vector embeddings.

16. The system of claim 15, wherein the server is configured to determine whether the highest similarity score is greater than or equal to a predetermined threshold score for similarity.

17. The system of claim 10, further comprising:
a generative artificial intelligence system communicatively coupled to the server,
wherein the generative artificial intelligence system is configured to generate the recommendation for adding to or modifying the at least one of the generated vector embeddings that is determined to be similar and transmit the generated recommendation to the server.

18. The system of claim 10, further comprising:
a generative artificial intelligence system communicatively coupled to the server,
wherein the generative artificial intelligence system is configured to generate the recommendation for leaving unchanged the at least one of the generated vector embeddings that is determined to be similar and transmit the generated recommendation to the server.
